(19) United States
(12) Patent Application Publication
(10) Pub. No.: US 2016/0078991 A1
(43) Pub. Date: Mar. 17, 2016

(54) Electrical Transducer

(71) Applicants: Roydan Tomlinson, College Place, WA (US); Daniel C. Wiggins, Montecito, CA (US)

(72) Inventors: Roydan Tomlinson, College Place, WA (US); Daniel C. Wiggins, Montecito, CA (US)

(73) Assignee: Key Technology, Inc., Walla Walla, WA (US)

(21) Appl. No.: 14/483,882

(22) Filed: Sep. 11, 2014

(51) Int. Cl. H01F 7/06

(52) U.S. Cl. CPC H01F 7/066

(57) ABSTRACT

An electrical transducer is described, and which includes a housing defining an internal cavity; a moveable electrical coil form received within the internal cavity; an electrical coil positioned on the moveable electrical coil form; a pair of magnets mounted in the internal cavity of the housing, and which cooperate with the electrical coil; a spring biased guide rod located within the housing and which cooperates with the electrical coil form; and a mounting fixture mounted on the electrical coil form.

### TECHNICAL FIELD

The present invention relates to an electrical transducer, and more specifically to an electrical transducer which may be employed to carry an object of interest, such as a severing device, and which may be utilized for cutting an object of interest, such as a food products, including vegetables, meats, poultry, and the like.

### BACKGROUND OF THE INVENTION

The processing of mass flow food products, such as french fries, vegetables, meat products, and the like, create a variety of technical challenges for equipment manufacturers.

Typically, mass flow food products include individual food items which are both acceptable and unacceptable in view of surface defects; contamination or the like. Further some food products may be admixed with various contaminants, including weeds, stones, rocks, foreign debris, and other material, and which must be separated from the mass flow food product in order to provide a resulting, substantially acceptable product stream, which is then later processed for packaging and shipment to an end user.

Often products, like french fries, for example, will have surface blemishes or other defects, such as rot, which only becomes evident once the product has been partially processed. Heretofore, food processing equipment manufacturers have utilized various devices to first image the product traveling in the product stream, so as to identify defective products, and then later, in a downstream processing step, these processors sever the product to separate the undesirable region of the product, such as the rot, from the product, and then subsequently remove the severed, undesirable region to produce a substantially uniform product.

While food handling and processing equipment of various designs have been introduced and have been utilized for decades, to accomplish the foregoing and other tasks, many difficulties have resulted from employing the prior art devices, which treat these mass flow food product streams. As a first matter, many of these devices are quite complex in their overall design, and are subject to malfunction because of the debris that may become deposited on, or lodged in these devices while handling a product stream, which may be admixed with foreign debris, dirt, and other materials. Still further, such devices can routinely become damaged or malfunction when the cutting devices employed by such prior art machines, engage relatively hard objects, such as stones, glass and other natural or synthetic objects, and which may have become inadvertently mixed with the product stream being processed. This damage of the cutting element(s) may include a breaking of a knife or other cutting element, or the fragmentation of the knife or other cutting element, thus introducing another piece of foreign debris into the product stream, and which subsequently could be inadvertently packaged with the resulting final food product.

As might be expected, the damage of such cuffing elements presents various problems for food processors, including production line downtime to isolate the particular cutting element which has become damaged, and then repairing and/or replacing the cutting element so as to place the food processing machine back into operation.

In view of the foregoing issues, designers of food processing machinery have looked for more reliable, and robust assemblies which can be employed to cut objects of interest such as individual items in a stream of food products in a manner which avoids the detriments associated with the individual prior art devices, that have been employed heretofore.

An electrical transducer which avoids the detriments of the prior art devices which have been utilized, heretofore, is the subject matter of present application.

### SUMMARY OF THE INVENTION

A first aspect of the present invention relates to an electrical transducer, which includes a housing having opposite first and second ends, and an internal cavity; a moveable electrical coil form having opposite first and second ends, and an internal cavity, and wherein the first end of the moveable electrical coil form is sized so as to be telescopingly received within the internal cavity of the housing, and wherein the second end of the moveable electrical coil form is mounted in spaced relation relative to the second end of the housing; an electrical coil received on, and about, the first end of the moveable electrical coil form; a first and second magnet mounted in the internal cavity of the housing, and which individually, and magnetically cooperate and interact with the electrical coil, when the electrical coil is energized; a guide rod having opposite first and second ends, and wherein the first end of the guide rod is located in spaced relation relative to the first end of the housing, and the second end of guide rod is located within the internal cavity of the moveable electrical coil form, and is further located in spaced relation relative to the second end of the housing, and wherein the first and second ends of the guide rod are biased in opposite directions, one relative to the other; and a mounting fixture located on the second end of the moveable electrical coil form, and wherein the second end of the guide rod is affixed to the mounting fixture.

Still another aspect of the present invention relates to an electrical transducer, which includes a housing defining an internal cavity; a guide rod having a main body with opposite first and second ends, and which further extends through the internal cavity of the housing; a first biasing spring which biasingly engages the first end of the guide rod, and which further is positioned between the first end of the guide rod and the housing; a first magnet shorting ring which defines an internal cavity, and which further is received in the internal cavity of the housing; a first magnet received within the internal cavity of the first magnet shorting ring; a moveable electrical coil form having opposite first and second ends, and further defining an internal cavity, and wherein the moveable electrical coil form has an outside facing surface, and the first end of the moveable electrical coil form is received within the internal cavity of the housing; an electrical coil which is positioned on and about the outside facing surface of the moveable electrical coil form, and is further located adjacent to the first end thereof, and wherein the electrical coil is further located within the internal cavity of the housing; a pair of metal washers which are received, at least in part, within the internal cavity of the moveable electrical coil form, and wherein a gap is defined between the respective metal washers; a gap shorting ring which defines a passageway extending therethrough, and wherein the gap shorting ring is located within the internal cavity of the housing, and the first end of the moveable electrical coil form is received through the passageway which is defined by the gap shorting ring; a second magnet shorting ring which defines an internal cavity, and which further is received in the internal cavity of the moveable electrical coil form; a second magnet received within the internal cavity which is defined by the second magnet shorting ring; a second biasing spring located within the internal cavity of the moveable electrical coil form, and which is further positioned between the second magnet and the second end of the guide rod; and a mounting fixture mounted on the second end of the moveable electrical coil form, and which is further engaged by the second end of the guide rod, and wherein energizing the electrical coil effects a predetermined reciprocal motion of the mounting fixture along a linear path of travel.

Still another aspect of the present invention relates to an electrical transducer, which includes a housing defined by an elongated and continuous sidewall, and wherein an endwall is made integral with the continuous sidewall, and wherein the housing further has a first and second end, and the end wall is mounted at the first end of the housing, and has a passageway which extends therethrough, and wherein the sidewall has an internal facing surface which defines an internal cavity of the housing, and wherein the continuous sidewall which is located at the second end of the housing defines an aperture which allows access to the internal cavity of the housing, and wherein an annular magnetic gap is formed in the internal facing surface of the continuous sidewall, and which is located in a position that is intermediate the opposite first and second ends of the housing; an elongated guide rod having a main body with opposite first and second ends, and wherein the elongated guide rod is received through the passageway which is formed in the end wall of the housing, and which further extends through the internal cavity defined by the housing, and wherein the respective first and second ends of the elongated guide rod are located in spaced relation relative to the individual first and second ends of the housing; a first biasing spring cooperating with the elongated guide rod, and which is located on the end wall of the housing, and is further coupled in force transmitting relation relative to the first end of the elongated guide rod; a first magnet shorting ring which has an outside facing surface, and which further defines an internal cavity, and wherein the first magnet shorting ring is concentrically positioned about the elongated guide rod, and is further located within the internal cavity of the housing, and mounted juxtaposed relative to the end wall, and wherein a first gap is defined between the outside facing surface of the first magnet shorting ring, and the inside facing surface of the housing; a first magnet which is telescopingly received within the internal cavity as defined by the first magnet shorting ring, and which is further concentrically oriented relative to the elongated guide rod; an elongated and moveable electrical coil form which is dimensioned so as to be concentrically received, at least in part, within the internal cavity as defined by the housing, and wherein the coil form has a first end received in the internal cavity of the housing, and an opposite second end which is positioned in spaced relation relative to the second end of the housing, and wherein the coil form has an outside facing surface which defines a first outside diametral dimensioned region at the first end of the coil form, and a second outside diametral dimensioned region which is located at the second end of the coil form, and wherein the outside diametral dimension of the first region is less than the second region, and wherein an electrical conductor is concentrically wound about the second region of the coil form, and wherein the electrical coil form defines an internal cavity which extends between the first and second ends thereof; a first metal washer concentrically received about the guide rod, and juxtaposed relative to the first magnet, and wherein the first metal washer has an outside facing surface which has a recessed region formed therein, and wherein at least a portion of the first metal washer, and the recessed region of the first metal washer, is telescopingly received within the internal cavity which is defined by the electrical coil form, and is further located at the first end thereof; a second metal washer which is concentrically received about the guide rod, and wholly received within the internal cavity as defined by electrical coil form, and wherein the second metal washer is juxtaposed relative to the first metal washer, and wherein the second metal washer has an outside facing surface which has a recessed region formed therein, and wherein the recessed region of the second metal washer is juxtaposed relative to the recessed region which is defined by the first metal washer, and wherein the respective recessed regions of the first and second metal washers define a gap therebetween; a gap shorting ring which is concentrically mounted within the internal cavity which is defined by the housing, and which further has an exterior facing surface, and an interior facing surface defining a passageway extending therethrough, and wherein the first end of the electrical coil former is received through the passageway which is defined by the internal facing surface of the gap shorting ring, and wherein the gap shorting ring is positioned in juxtaposed covering relation relative to the annular magnetic gap which is defined by the interior facing surface of the housing; a second magnet shorting ring which has an outside facing surface, and further defines an internal cavity, and wherein the second magnet shorting ring is concentrically positioned about the elongated guide rod, and is further located within the internal cavity of electrical coil form, and is further mounted in juxtaposed relation relative to the second metal washer; a second magnet which is telescopingly received within the internal cavity as defined by the second magnet shorting ring, and wherein the second magnet is juxtaposed relative to the second metal washer; a second biasing spring cooperating with the elongated guide rod, and which is further located between the second magnet, and the second end of the guide rod, and wherein the second biasing spring exerts a biasing force which acts upon the second end of the guide rod; and a mounting fixture which is releasably affixed to the second end of the guide rod, and which is further received, at least in part, within the internal cavity which is defined by the electrical coil form, and wherein the energizing of the concentric electrical coil effects a reciprocal motion of the elongated and moveable coil form so as to propel the mounting fixture along a linearly, reciprocal path of travel.

These and other aspects of the present invention will be discussed in greater detail hereinafter.

### BRIEF DESCRIPTION OF THE DRAWINGS

Preferred embodiments of the invention are described below, with reference to the following accompanying drawings.

FIG. 1 is a perspective, side elevation view of the electrical transducer of the present invention.

FIG. 2 is a fragmentary, perspective, side elevation view of the electrical transducer, as seen in FIG. 1.

FIG. 3 is a longitudinal, transverse, vertical, sectional view taken from a position along line 3-3 of FIG. 2.

FIG. 4 is a first end view of the electrical transducer, as seen in FIG. 1.

FIG. 5 is a longitudinal, sectional view taken through a retainer cap, which forms a feature of the present invention.

FIG. 6 is a perspective, side elevation view of a guide rod, which forms a feature of the present invention.

FIG. 7 is a perspective, side elevation view of a housing, which forms a feature of the present invention.

FIG. 8 is a longitudinal, vertical, sectional view taken from a position along line 8-8 of FIG. 7.

FIG. 9 is a perspective, side elevation view of a gap shorting ring, which forms a feature of the present invention.

FIG. 10 is a perspective, side elevation view of a metal washer, which forms a feature of the present invention.

FIG. 10A is a perspective, side elevation view of a second metal washer, which forms a feature of the present invention,

FIG. 11 is a perspective, side elevation view of a magnet shorting ring, which forms a feature of the present invention.

FIG. 11A is a perspective, side elevation view of a second magnet shorting ring, which forms a feature of the present invention.

FIG. 12 is a perspective, side elevation view of a mounting fixture, which forms a feature of the present invention.

FIG. 13 is a perspective, side elevation view of an electrical coil form, which forms a feature of the present invention.

FIG. 14 is a somewhat simplistic depiction, and side elevation view of an electrical coil, which forms a feature of the present invention.

FIGS. 15 and 16 are perspective, side elevation views of first and second magnets, which form features of the present invention.

### DETAILED DESCRIPTION OF THE PREFERRED EMBODIMENT

This disclosure of the invention is submitted in furtherance of the constitutional purposes of the U.S. Patent law “to promote the progress of science in useful arts” [Article I, Section 8].

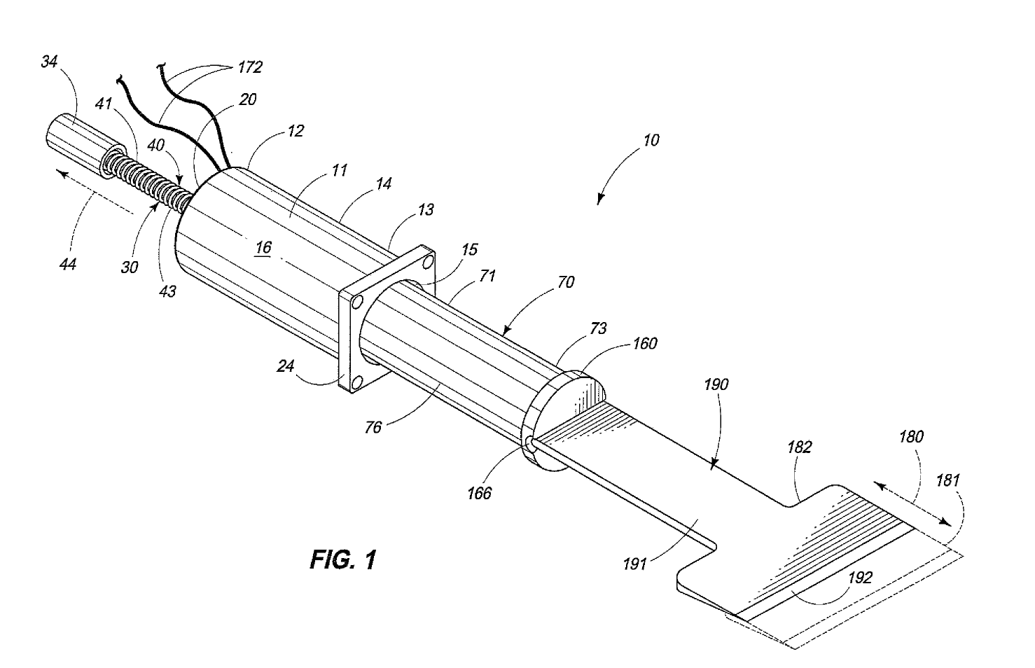

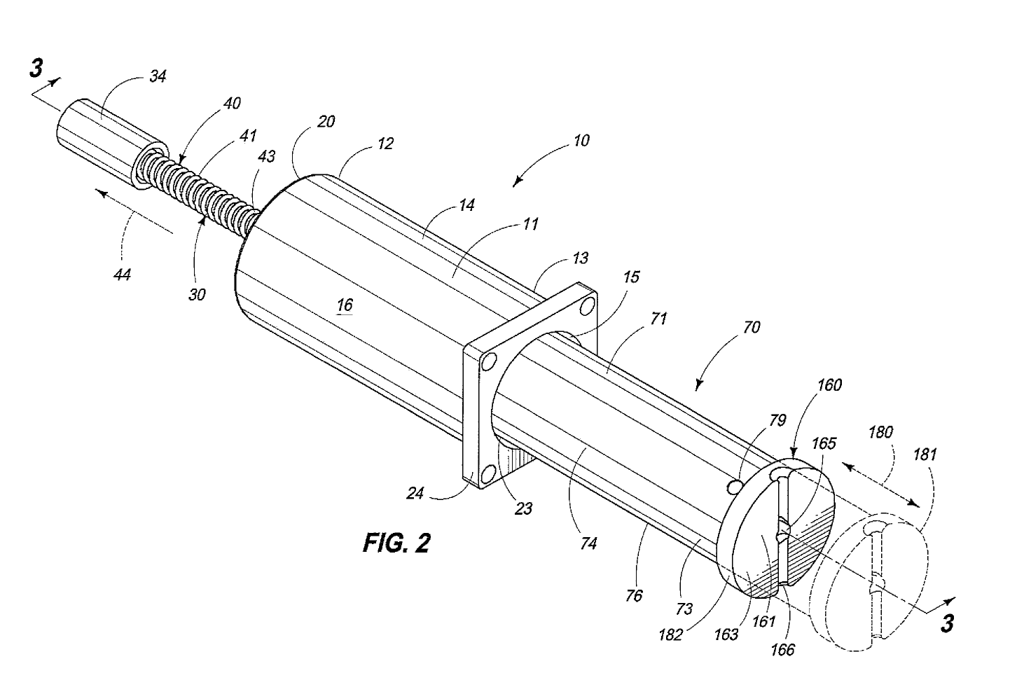

An electrical transducer of the present invention is generally indicated by the numeral 10 in FIG. 1 and following. As seen in the drawings, the electrical transducer 10 is formed, at least in part, of a housing which is indicated by the numeral 11. The housing as depicted is generally cylindrically shaped, and which further has a first end 12, and an opposite second end 13. Still further, the housing has an exterior facing surface 14, and an opposite interior facing surface 15. The housing 11, as described, is fabricated from a suitable electrically conductive metal. The metal is selected such that it may operate in a high moisture or corrosive environment with no deleterious effects.

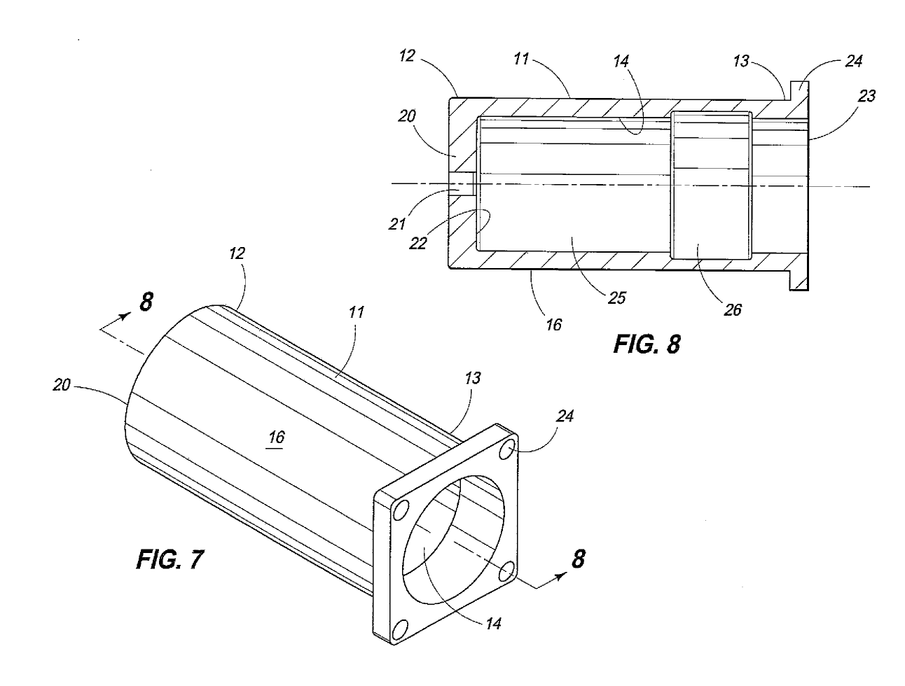

The housing 11 is defined, at least in part, by an end wall that is generally indicated by the numeral 20, and which is further made integral with the continuous sidewall 16, and which generally forms the housing 11. As seen in the drawings, the end wall 20 has a smaller, centrally disposed passageway 21, and which is formed therein. The end wall 20 has an internal facing surface 22 which faces inwardly relative to the housing 11. As seen in FIG. 8, the end wall is positioned on the first end 12 of the housing 11. Still further and as seen in the drawings (FIGS. 7 and 8), the second end 13 of the housing 11 defines an aperture 23 which allows access to the internal cavity 25 as defined by the interior facing surface 15. Still further, the interior facing surface 15 of the housing 11 defines an annular shaped magnetic gap 26 which is formed in the interior facing surface 15, and which is located between the first and second ends of the housing 12 and 13, respectively.

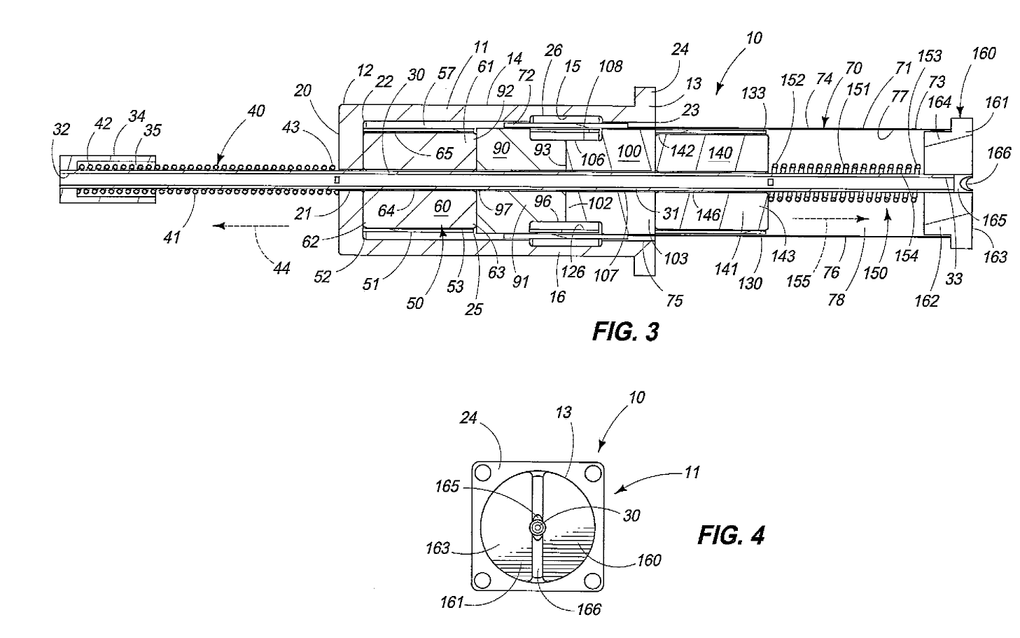

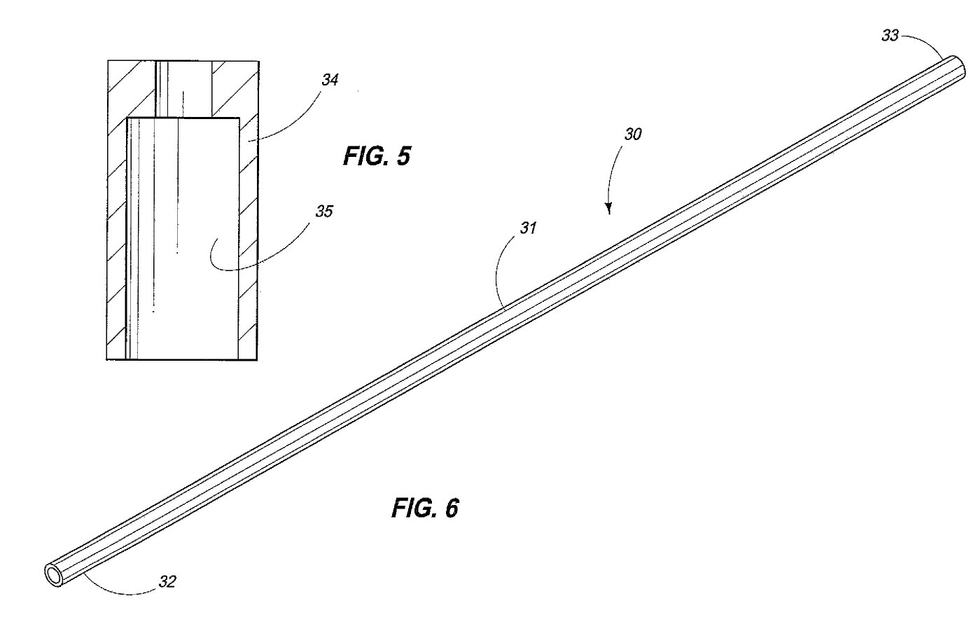

The present invention 10 includes an elongated guide rod which is generally indicated by the numeral 30, and which further has a narrowly cylindrically shaped main body 31 which has a first end 32, and an opposite second end 33. As seen in the drawings (FIG. 3), the respective first and second ends 32 and 33, respectively, are located in spaced relation relative to the individual first and second ends 12 and 13 of the housing 11, as previously described. The invention 10 further includes a retainer cap 34 which is operable to be releasably affixed on the first end 32 of the elongated guide rod. The retainer cap 34 has an internal cavity 35 which is operable to receive, at least in part, a portion of a first biasing spring which will be discussed in greater detail in the paragraphs which follow.

The electrical transducer 10 of the present invention includes a first biasing spring 40 which cooperates with the elongated guide rod 30, and which is further located on, and extends outwardly relative to, the first end 12 of the housing 11. As will be recognized, the first biasing spring 40 is coupled in force transmitting relation relative to the first end 32 of the elongated guide rod 30. More specifically, the first biasing spring has a main body 41 defining a central passageway which is dimensioned to receive the first end 32 of the elongated guide rod 30 therethrough. The main body has a first end 42, and an opposite second end 43. The second end 43 rests in force transmitting relation relative to the end wall 20. As illustrated in FIGS. 1 and 3, the first end 42 of the first biasing spring 40 is received within the internal cavity 35, as defined by the retainer cap 34. As will be appreciated from a study of the drawings, the first biasing spring exerts a biasing force 44 which urges the first end 32 of the elongated guide rod 30 generally longitudinally outwardly relative to the first end 12 of the housing 11.

The electrical transducer 10 as described herein (FIGS. 3 and 11) includes a first magnet shorting ring 50 which has an annular shaped main body 51, and which further has a first end 52, and an opposite second end 53. The annular shaped main body 51 has an outside facing surface 54, and which defines a predetermined outside diametral dimension which is less than the inside diametral dimension of the internal cavity 25 of the housing 11 (FIG. 3). Still further, the annular shaped main body 51 of the first magnet shorting ring 50 has an inside facing surface 55 which defines an internal cavity 56. As seen in the drawings, the first magnet shorting ring 50 is concentrically positioned about the elongated guide rod 30, and is further located within the internal cavity 25 of the housing 11, and is further mounted in juxtaposed relation relative to the internal facing surface 22 of the end wall 20. As should be understood, a first gap 57 (FIG. 3) is defined between the outside facing surface 54 of the first magnet shorting ring 50 and the inside facing surface 15 of the housing 11.

The electrical transducer of the present invention includes a first magnet which is generally indicated by the numeral 60, (FIGS. 3 and 15) and which has a main body 61, and which further is telescopingly received within the internal cavity 25 as defined by the housing 11. The first magnet 60 is concentrically oriented relative to the elongated guide rod 30, as earlier described. The first magnet 60 further has a main body 61 which has a first end 62, and which further is juxtaposed relative to the internal facing surface 22 of the end wall 20; and a second end 63 which is located adjacent to the second end 53 of the first magnet shorting ring 50. The first magnet 60 has an interior facing surface 64 which defines a passageway, or internal cavity 66 which extends therethrough, and further has an exterior facing surface 65 which is dimensional so as to allow the main body 61 to be telescopingly received within the internal cavity 56, of the first magnet shorting ring 50. This is best seen by reference to FIG. 3. The first magnet 60 has a given first polarity.

Referring now to FIG. 13, the electrical transducer 10 includes an elongated and movable electrical coil form 70 and which is dimensioned so as to be concentrically received, at least in part, within the internal cavity 25, and which is defined by the housing 11. As seen in FIGS. 3 and 13, the coil form has a main body 71, which has a first end 72, and which further is received within the internal cavity 25 of the housing 11; and an opposite second end 73, which is positioned in spaced relation relative to the second end 13 of the housing 11. The coil form 70 has an outside facing surface 74 which defines a first outside diametral dimensioned region 75 at the first end 72 of the coil form; and a second outside diametral dimensioned region 76, and which is located at the second end 73 of the coil form 70. The outside diametral dimension of the first region is greater, than that of the second region. As should be appreciated from the drawings, and the discussion which follows, an electrical conductor which will be described in greater detail, hereinafter, is concentrically wound about the second outside diametral dimensioned region 76 of the coil form 70. The electrical coil form 70 defines an internal cavity 78 which extends between the first and second ends thereof 72 and 73, respectively. As seen in FIG. 13, a multiplicity of apertures 79 are formed in the second end 73, and which individually function to secure, at least in part, a mounting fixture to the electrical coil form 70, as will be described, hereinafter.

The electrical transducer 10 of the present invention includes a first metal washer 90 (FIGS. 3 and 10) and which is received about the elongated guide rod 30, and which further is juxtaposed relative to the first magnet 60. The first metal washer has a main body 91 which has a first end 92 and an opposite second end 93. Still further, the main body 91 has an outside facing surface 94 and an inside facing surface 95. A recessed region is formed in the outside facing surface, and is further located near the second end 93. As seen in the drawings (FIG. 3), at least a portion of the first metal washer 90, and the recessed region of the first metal washer 96 is telescopingly received within the internal cavity 78, and which is defined by the elongated movable electrical coil form 70, and is further located at the first end 72 thereof.

The electrical transducer of the present invention 10 includes a second metal washer 100 (FIG. 10A), and which is substantially identical to the first metal washer 90. The second metal washer 100, again, has a main body 101 which is defined by a first end 102, and an opposite second end 103. The main body 101 has an outside facing surface 104, and an inside facing surface 105. A recessed region 106 is formed in the outside facing surface 104 and is juxtaposed adjacent to the recessed region 96 as defined by the main body 91 of the first metal washer (FIG. 3). Again, a passageway 107 is formed in the main body, and is substantially coaxially aligned relative to the passageway 97 and which is formed in the main body 91 of the first metal washer. As should be appreciated from the drawings, the main body of the elongated guide rod 30 passes through the coaxially aligned passageways 97 and 107, respectively. As seen in the drawings (FIG. 3), the second metal washer 100 is concentrically received about the guide rod 30, and wholly received within the internal cavity 78 as defined by the electrical coil form 70. As illustrated in the drawings, the second metal washer 100 is juxtaposed relative to the first metal washer 90. As illustrated in FIG. 3, the recessed region 106 of the second metal washer 100 is located in juxtaposed relation relative to the recessed region 96 of the first metal washer 90. The respective recessed regions 96 and 106, respectively define, in combination, a gap 108 of predetermined dimensions, therebetween.

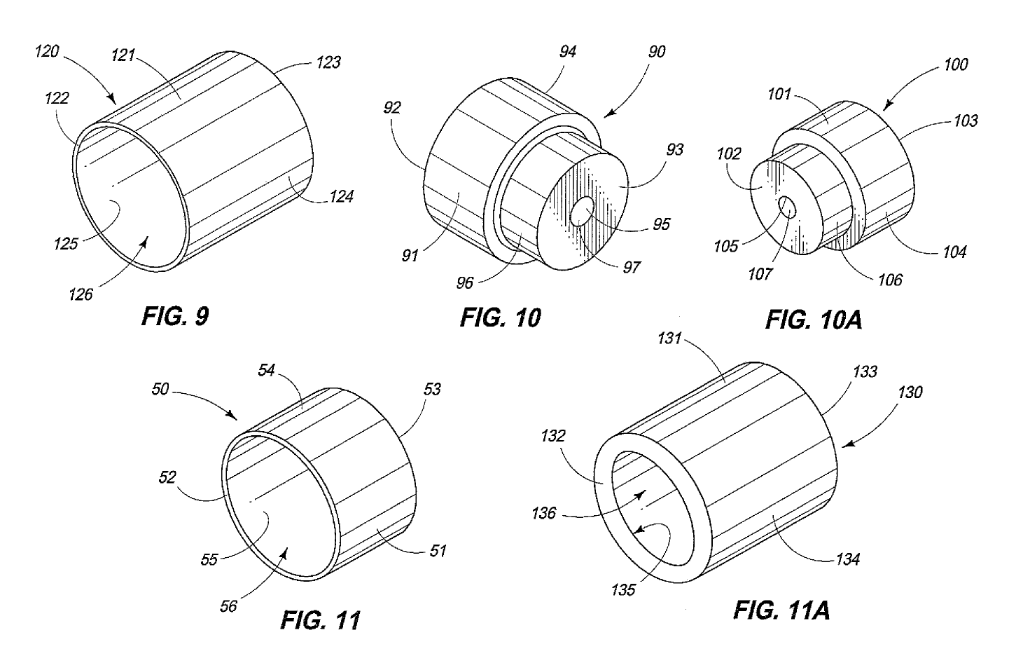

The electrical transducer 10 further includes a gap shorting ring which is generally indicated by the numeral 120 (FIGS. 3 and 9). The gap shorting ring as seen in FIG. 9 has a main body 121 which has a first end 122, and an opposite second end 123. Still further, the main body 121 has an exterior facing surface 124, and an opposite interior facing surface 125. The interior facing surface 125 defines a passageway 126 that extends therethrough. The gap shorting ring 120 is concentrically or coaxially mounted within the internal cavity 25 which is defined by the housing 11. As seen in the drawings, the first end of the elongated and movable electrical coil form 70 is received in the passageway 126, and which is defined by the internal facing surface 125 of the gap shorting ring 120. The gap shorting ring 120 is positioned in juxtaposed, covering relation relative to the annular magnetic gap 26, and which is formed and defined by the interior facing surface 15 of the housing 11. This is best seen by reference to FIGS. 3 and 8, respectively.

The electrical transducer 10 of the present invention includes a second magnet shorting ring, and which is generally indicated by the numeral 130 in FIG. 11A. The second magnet shorting ring 130 is similar to the first magnet shorting ring 50 inasmuch as the second magnet shorting ring has an annular shaped main body 131. The second magnet shorting ring 130 further has a first end 132, and an opposite second end 133. The main body is also further defined by an outside facing surface 134, and an opposite inside facing surface 135. The inside facing surface 135 defines an internal cavity or passageway 136 which passes or extends therethrough. As seen in the drawings, the second magnet shorting ring 130 is concentrically, and coaxially positioned about the elongated guide rod 30, and is further located within the internal cavity 78 of the elongated and movable electrical coil forms 70. Still further, the second magnet shorting ring is mounted in juxtaposed relation relative to the second end 103 of the second metal washer 100.

The electrical transducer 10 of the present invention includes a second magnet 140 (FIG. 16) which is similar in construction to the first magnet 60, as earlier described. However, the second magnet has a predetermined polarity which is opposite to the first magnet 60. The second magnet has a main body 141 which has opposite first and second ends 142 and 143, respectively. Still further, the main body is defined by an exterior facing surface 144, and further has an interior facing surface 145, and which defines a passageway 146 that passes or extends therethrough. The second magnet is sized so as to be telescopingly received within the internal cavity 136 as defined by the second magnet shorting ring 130. As best illustrated in FIG. 3, the second magnet 140 is juxtaposed relative to the second metal washer 100 as earlier described. The passageway 146 is sized so as to receive the main body of the elongated guide rod 30 therethrough.

The electrical transducer 10 of the present invention includes a second biasing spring which generally indicated by the numeral 150 (FIG. 3). The second biasing spring, which is similar to the first biasing spring 40, has a resilient main body 151 having a first end 152, and an opposite second end 153. The main body 151 defines a passageway 154 which is sized so as to receive the main body of the elongated guide rod 30 therethrough. The second biasing spring 150 exerts a biasing force which is generally indicated by the arrow labeled 155. The second end 153 of the main body 151 biases the second end 33 of the elongated guide rod 30 in a direction longitudinally outwardly relative to the second end 13 of the housing 11. The biasing force 155, as illustrated, is in opposition to the biasing force 44, and which acts on the first end 32 of the elongated guide rod 30.

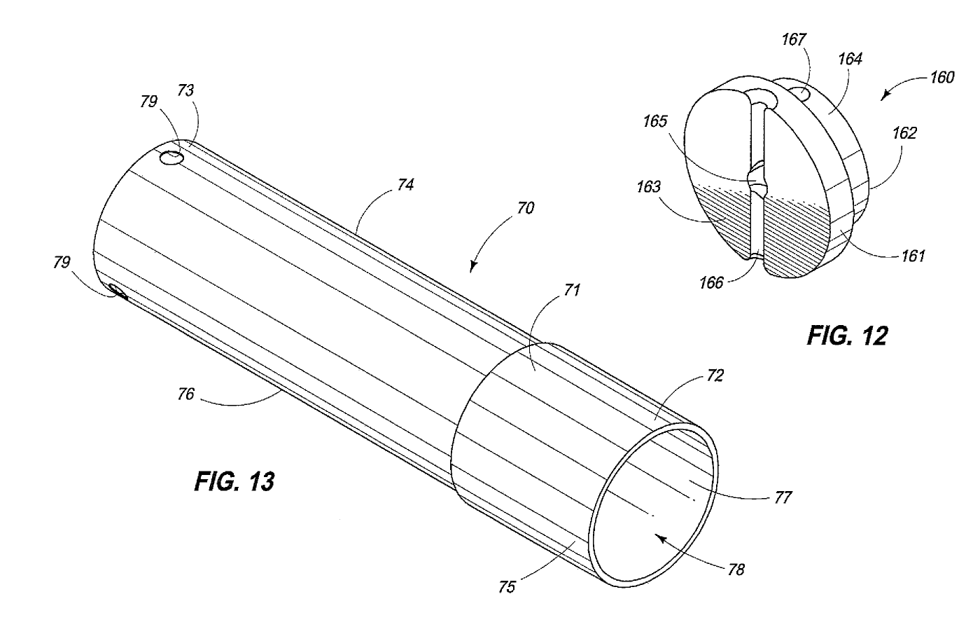

The present invention 10 includes a mounting fixture which is generally indicated by the numeral 160, and which is releasably affixed to the second end 33 of the elongated guide rod 30. The mounting fixture is further received, at least in part, within the internal cavity 78 of the elongated movable electrical coil form 70, and which was earlier described (FIGS. 3, 4 and 12). The mounting fixture 160 has a main body 161 which has a first end 162, and which is dimensioned to be telescopingly received within the internal cavity 78 of the elongated movable electrical coil form, and a second outwardly facing end 163. The main body has a reduced dimensioned outside region 164 which is received within the internal cavity of the elongated coil form 70. Still further, a passageway 165 is formed or otherwise extends through the main body 161, and is operable to matingly receive the second end 33 of the elongated guide rod 30 therein. Still further, and formed in the second end 163 of the main body 161 is a transverse receiving aperture 166, and which is operable to matingly cooperate with an object of interest which is carried by the second end 163 of the mounting fixture so as to achieve at least some of the objectives of the present invention. As seen in the drawings, a fastener aperture 167 is formed in the reduced dimensioned outside region 164 of the main body 161. As will be appreciated, a fastener (not shown) is received through the individual apertures 79 which are formed in the elongated and movable electrical coil form 70 and into the fastener aperture 167 so as to releasably secure the mounting fixture 160 in substantially occluding relation relative to the internal cavity 78 thereof, and at the second end 73.

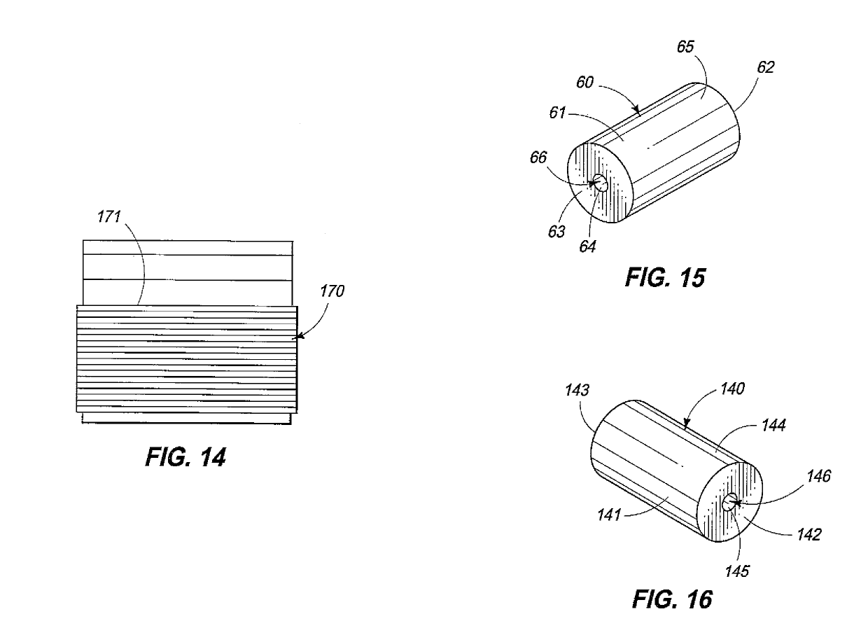

The present invention includes an electrical coil (FIGS. 3 and 14) and which is generally indicated by the numeral 170, and which is formed or fabricated of a continuous electrical conductor 171. The electrical coil 170 which is fabricated from the continuous electrical conductor 171 is wrapped on and about, the second outside diametral dimensioned region 76 as defined by the elongated and movable electrical coil form 70, and is further movable with the electrical coil form relative to the first and second magnets 60 and 140 respectively, as described earlier. The electrical coil 170 is energized by an outside electrical power source supplied by an electrical conduit 172 as illustrated in FIG. 1. When selectively energized, the elongated and moveable electrical coil form 70 is operable to move along a linear and reciprocal path of travel which is generally indicated by the numeral 180. The reciprocal path of travel which is defined between a first extended position 181, and a second or retracted position 182. As should be understood, the electrical transducer 10 can be employed to cooperate with various objects of interest. As illustrated in FIG. 1 and following, a severing device or knife 190 is provided, and which is mounted on the mounting fixture 160, and which is further carried along the path of travel 180. The severing device 190 has a longitudinally extending shaft 191 which carries a cutting member 192 distally thereof. When employed in food processing devices, the cutting member 192 would be moved along the path of travel 180 into, and out of engagement with objects of interest, such as vegetables, meat products and the like in order to sever these objects in an appropriate manner for subsequent downstream processing.

### Operation

The operation of the described embodiment of the present invention is believed to be readily apparent, and is briefly summarized at this point.

In its broadest aspect, the present invention relates to an electrical transducer 10 which includes a housing 11 having opposite first and second ends 12 and 13, respectively. The housing 11 further defines an internal cavity 25. The electrical transducer further includes a moveable electrical coil form 70 having opposite first and second ends 72 and 73 respectively, and which further defines an internal cavity 78. The first end 72 of the moveable electrical coil form 70 is sized so as to be telescopingly received within the internal cavity 25 of the housing 11. The second end 73 of the moveable electrical coil form 70 is mounted in spaced relation relative to the second end of the housing 11. The electrical transducer 10 further includes an electrical coil 170 which is received on, and about, the moveable electrical coil form 70. Additionally, the electrical transducer includes first and second magnets 60 and 140, respectively, and which are mounted in the internal cavity 25 of the housing 11, and which individually, magnetically cooperate, and interact with the electrical coil 170, when the electrical coil is energized. The electrical transducer 70 further includes a guide rod 30 having opposite first and second ends 32 and 33, respectively. The first end 32 of the guide rod 30 is located in spaced relation relative to the first end 12 of the housing 11, and the second end of guide rod is located within the internal cavity 78 of the moveable electrical coil form 70, and is further located in spaced relation relative to the second end 13 of the housing 11. The first and second ends of the guide rod 30 are biased in opposite directions, one relative to the other. The electrical transducer 10 as described includes a mounting fixture 160 which is located on the second end 73 of the moveable electrical coil form 70. The second end 33 of the guide rod 30 is affixed to the mounting fixture 160.

The electrical transducer 10, as described, further includes a severing device 190 which is releasably affixed to the mounting fixture 160, and which is operable to sever an object of interest when propelled along a linear path of travel 180 by the moveable electrical coil form 70. The movement of the electrical coil form 70 is effected by energizing the electrical coil 170 from an outside electrical power source (not shown). The electrical transducer 10 further includes first and second magnet shorting rings 50 and 130 respectively, and which cooperate with the first and second magnets 60 and 140, respectively. The first magnet shorting ring 50 is received within the internal cavity 25 of the housing 11, and the second magnet shorting ring 130 is located within the internal cavity 78 as defined by the moveable electrical coil form 70. In the arrangement as seen in the drawings, the electrical transducer 10 includes first and second metal washers 90 and 100, respectively, and which are disposed in juxtaposed relation relative to each other. The first and second metal washers 90 and 100 are located between the first and second magnets 60 and 140, respectively. As earlier discussed, a gap 108 is defined between the first and second metal washers 90 and 100, respectively.

The electrical transducer 10, as described, further includes a gap shorting ring 120 which is located within the internal cavity 25 of the housing 11, and which further operably cooperates with the first and second metal washers 90 and 100. The gap shorting ring 120 is oriented concentrically, outwardly relative to the first and second metal washers 90 and 100, respectively. The electrical transducer 10 further includes first and second biasing springs 40 and 150, respectively. As should be understood, the guide rod 30 passes through each of the biasing springs 40 and 150, respectively. The first biasing spring 40 is located between the first end 12 of the housing 11, and the first end 32 of the guide rod 30; and the second biasing spring 150 is positioned between the second end 73 of the moveable electrical coil form 70, and the second magnet 140. The second biasing spring 150 is further located within the internal cavity 78 as defined by the moveable electrical coil form 70. In the arrangement as seen in the drawings, the first and second magnets 60 and 140, respectively, each have magnetic polarities which are inverted. Those skilled in the art will recognize that the selective energizing of the electrical coil 170 is effective to cause reciprocal motion of the electrical coil form 70 along a path of travel as earlier described. Further, the respective biasing springs 40 and 150, respectively, return the electrical coil form to the position as seen in FIG. 3.

Therefore, it will be seen that the electrical transducer 10 as described is compact; can be effectively and selectively energized so as to effect movement of the coil form 70 along a given path of travel 180 to carry objects of interest such as a severing device 190 along a predetermined path of travel; and further avoids the detriments associated with the prior art practices utilized heretofore inasmuch as that the performance of the electrical transducer 10 can be monitored remotely to determine a malfunction of the transducer or further damage of the object of interest such as the severing device 190 which is being carried along the predetermined course of travel 180.

In compliance with the statute, the invention has been described in language more or less specific as to structural and methodical features. It is to be understood, however, that the invention is not limited to the specific features shown and described since the means herein disclosed comprise preferred ways of putting the invention into effect. The invention is, therefore, claimed in any of its forms or modifications within the proper scope of the appended claims appropriately interpreted in accordance with the Doctrine of Equivalence.

We claim:

1. An electrical transducer, comprising:
a housing having opposite first and second ends, and an internal cavity;
a moveable electrical coil form having opposite first and second ends, and an internal cavity, and wherein the first end of the moveable electrical coil form is sized so as to be telescopingly received within the internal cavity of the housing, and wherein the second end of the moveable electrical coil form is mounted in spaced relation relative to the second end of the housing;
an electrical coil received on, and about, the first end of the moveable electrical coil form;
a first and second magnet mounted in the internal cavity of the housing, and which individually magnetically cooperate and interact with the electrical coil, when the electrical coil is energized;
a guide rod having opposite first and second ends, and wherein the first end of the guide rod is located in spaced relation relative to the first end of the housing, and the second end of guide rod is located within the internal cavity of the moveable electrical coil form, and is further located in spaced relation relative to the second end of the housing, and wherein the first and second ends of the guide rod are biased in opposite directions, one relative to the other; and
a mounting fixture located on the second end of the moveable electrical coil form, and wherein the second end of the guide rod is affixed to the mounting fixture.

2. An electrical transducer as claimed in claim 1, and further comprising a severing device which is releasably affixed to the mounting fixture, and which is operable to sever an object of interest when propelled along a linear path of travel by the moveable electrical coil form.

3. An electrical transducer as claimed in claim 2, and further comprising first and second magnet shorting rings which cooperate with the first and second magnets, respectively, and wherein the first magnet shorting ring is received within the internal cavity of the housing, and the second magnet shorting ring is located within the internal cavity as defined by the moveable electrical coil form.

4. An electrical transducer as claimed in claim 3, and further comprising first and second metal washers which are disposed in juxtaposed relation relative to each other, and wherein the first and second metal washers are located between the first and second magnets, and wherein a gap is defined between the first and second metal washers.

5. An electrical transducer as claimed in claim 4, and further comprising a gap shorting ring which is located within the internal cavity of the housing, and which further cooperates with the first and second metal washers, and wherein the gap shorting ring is oriented concentrically, outwardly relative to the first and second metal washers.

6. An electrical transducer as claimed in claim 5, and further comprising first and second biasing springs, and wherein the guide rod passes through each of the biasing springs, and wherein the first biasing spring is located between the first end of the housing, and the first end of the guide rod, and the second biasing spring is positioned between the second end of the moveable electrical coil form, and the second magnet, and is further located within the internal cavity as defined by the moveable electrical coil form.

7. An electrical transducer as claimed in claim 6, and wherein the first and second magnets have polarities which are inverted.

8. An electrical transducer, comprising:
a housing defining an internal cavity;
a guide rod having a main body with opposite first and second ends, and which further extends through the internal cavity of the housing;
a first biasing spring which biasingly engages the first end of the guide rod, and which further is positioned between the first end of the guide rod and the housing;
a first magnet shorting ring which defines an internal cavity, and which further is received in the internal cavity of the housing;
a first magnet received within the internal cavity of the first magnet shorting ring;
a moveable electrical coil form having opposite first and second ends, and further defining an internal cavity, and wherein the moveable electrical coil form has an outside facing surface, and the first end of the moveable electrical coil form is received within the internal cavity of the housing;
an electrical coil which is positioned on and about the outside facing surface of the moveable electrical coil form, and is further located adjacent to the first end thereof, and wherein the electrical coil is further located within the internal cavity of the housing;
a pair of metal washers which are received, at least in part, within the internal cavity of the moveable electrical coil form, and wherein a gap is defined between the respective metal washers;
a gap shorting ring which defines a passageway extending therethrough, and wherein the gap shorting ring is located within the internal cavity of the housing, and the first end of the moveable electrical coil form is received through the passageway which is defined by the gap shorting ring;
a second magnet shorting ring which defines an internal cavity, and which further is received in the internal cavity of the moveable electrical coil form;
a second magnet received within the internal cavity which is defined by the second magnet shorting ring;
a second biasing spring located within the internal cavity of the moveable electrical coil form, and which is further positioned between the second magnet and the second end of the guide rod; and
a mounting fixture mounted on the second end of the moveable electrical coil form and which is further engaged by the second end of the guide rod, and wherein energizing the electrical coil effects a predetermined reciprocal motion of the mounting fixture along a linear path of travel.

9. An electrical transducer as claimed in claim 8, and wherein the housing is defined by an elongated, and continuous sidewall, and further has opposite first and second ends, and wherein the housing further includes an endwall which is made integral with the continuous sidewall, and which further has a passageway formed therein, and wherein the end wall is positioned at the first end of the housing, and wherein the second end of the housing defines an aperture which allows access to the internal cavity thereof, and wherein the continuous sidewall has an internal facing surface which defines an annular shaped magnetic gap which is located between the first and second ends of the housing.

10. An electrical transducer as claimed in claim 9, and wherein the elongated guide rod passes through each of the first biasing spring; the passageway defined by the end wall; the internal cavity defined by the housing; the first magnet shorting ring; the first magnet; the internal cavity defined by the moveable electrical coil form; the electrical coil; the pair of metal washers; the gap shorting ring; the second magnet; the second magnet shorting ring; and the second biasing spring, and wherein the first and second end of the elongated guide rod is located in spaced relation relative to the first and second ends of the housing.

11. An electrical transducer as claimed in claim 10, and wherein the first and second biasing springs biasingly urge the first and second ends of the elongated guide rod in a direction away from the first and second ends of the housing.

12. An electrical transducer as claimed in claim 11, and wherein the outside facing surface of the elongated, moveable electrical coil form defines first and second outside diametral dimensioned regions, and wherein the first outside diametral dimensioned region has a diametral dimension less than the second diametral dimensioned region, and is further located adjacent to the first end of the elongated, moveable electrical coil form, and wherein the electrical coil is located in the first outside diametral dimensioned region of the elongated, moveable electrical coil form.

13. An electrical transducer as claimed in claim 12, and wherein the gap shorting ring is disposed in covering relation relative to the gap which is defined between the first and second metal washers, and the annular magnetic gap which is formed in the internal facing surface of the continuous sidewall of the housing.

14. An electrical transducer as claimed in claim 13, and wherein the first biasing spring is positioned between the end wall and the first end of the elongated guide rod, and wherein the first magnet shorting ring is located within the internal cavity defined by the housing and is juxtaposed relative to the end wall, and wherein the first magnet cooperates with the first magnet shorting ring, and is further juxtaposed relative to the end wall, and wherein the pair of metal washers include a first metal washer which is juxtaposed relative to the first magnet, and a second metal washer which is juxtaposed relative to the first metal washer, and wherein the gap shorting ring cooperates with each of the first and second metal washers, and wherein the second magnet is juxtaposed to the second metal washer; and the second magnet shorting ring is also juxtaposed relative to the second magnet, and wherein the second biasing spring is positioned between the second magnet and the mounting fixture which is mounted on the second end of the guide rod.

15. An electrical transducer as claimed in claim 14, and wherein the first and second magnets have a magnetic polarity which is inverted.

16. An electrical transducer as claimed in claim 15, and further comprising;
a severing device which is releasably affixed to the mounting fixture, and which further engages, and severs an object of interest when the reciprocal motion of the moveable electrical coil form moves the mounting fixture along the linear path of travel.

17. An electrical transducer, comprising:
a housing defined by an elongated and continuous sidewall, and wherein an endwall is made integral with the continuous sidewall, and wherein the housing further has a first and second end, and the end wall is mounted at the first end of the housing, and has a passageway which extends therethrough, and wherein the sidewall has an internal facing surface which defines an internal cavity of the housing, and wherein the continuous sidewall which is located at the second end of the housing defines an aperture which allows access to the internal cavity of the housing, and wherein an annular magnetic gap is formed in the internal facing surface of the continuous sidewall, and which is located in a position that is intermediate the opposite first and second ends of the housing;
an elongated guide rod having a main body with opposite first and second ends, and wherein the elongated guide rod is received through the passageway which is formed in the end wall of the housing, and further extends through the internal cavity defined by the housing, and wherein the respective first and second ends of the elongated guide rod are located in spaced relation relative to the individual first and second ends of the housing;
a first biasing spring cooperating with the elongated guide rod, and which is located on the end wall of the housing, and is further coupled in force transmitting relation relative to the first end of the elongated guide rod;
a first magnet shorting ring which has an outside facing surface, and further defines an internal cavity, and wherein the first magnet shorting ring is concentrically positioned about the elongated guide rod, and is further located within the internal cavity of the housing, and mounted juxtaposed relative to the end wall, and wherein a first gap is defined between the outside facing surface of the first magnet shorting ring, and the inside facing surface of the housing;
a first magnet which is telescopingly received within the internal cavity as defined by the first magnet shorting ring, and which is further concentrically oriented relative to the elongate guide rod;
an elongated and moveable electrical coil form which is dimensioned so as to be concentrically received, at least in part, within the internal cavity as defined by the housing, and wherein the coil form has a first end received in the internal cavity of the housing, and an opposite second end which is positioned in spaced relation relative to the second end of the housing, and wherein the coil form has an outside facing surface which defines a first outside diametral dimensioned region at the first end of the coil form, and a second outside diametral dimensioned region which is located at the second end of the coil form, and wherein the outside diametral dimension of the first region is greater than the second region, and wherein an electrical conductor is concentrically wound about the second region of the coil form, and wherein the electrical coil form defines an internal cavity which extends between the first and second ends thereof;
a first metal washer concentrically received about the guide rod, and juxtaposed relative to the first magnet, and wherein the first metal washer has an outside facing surface which has a recessed region formed therein, and wherein at least a portion of the first metal washer, and the recessed region of the first metal washer, is telescopingly received within the internal cavity which is defined by the electrical coil form, and is further located at the first end thereof;
a second metal washer which is concentrically received about the guide rod, and wholly received within the internal cavity as defined by electrical coil form, and wherein the second metal washer is juxtaposed relative to the first metal washer, and wherein the second metal washer has an outside facing surface which has a recessed region formed therein and wherein the recessed region of the second metal washer is juxtaposed relative to the recessed region which is defined by the first metal washer, and wherein the respective recessed regions of the first and second metal washers define a gap therebetween;
a gap shorting ring which is concentrically mounted within the internal cavity which is defined by the housing, and which further has an exterior facing surface, and an interior facing surface defining a passageway extending therethrough, and wherein the first end of the electrical coil form is received through the passageway which is defined by the internal facing surface of the gap shorting ring, and wherein the gap shorting ring is positioned in juxtaposed, covering relation relative to the annular magnetic gap which is defined by the interior facing surface of the housing;
a second magnet shorting ring which has an outside facing surface, and further defines an internal cavity, and wherein the second magnet shorting ring is concentrically positioned about the elongated guide rod, and is further located within the internal cavity of electrical coil form, and is further mounted in juxtaposed relation relative to the second metal washer;
a second magnet which is telescopingly received within the internal cavity as defined by the second magnet shorting ring, and wherein the second magnet is juxtaposed relative to the second metal washer;
a second biasing spring cooperating with the elongated guide rod, and which is further located between the second magnet, and the second end of the guide rod, and wherein the second biasing spring exerts a biasing force which acts upon the second end of the guide rod; and
a mounting fixture which is releasably affixed to the second end of the guide rod, and which is further received, at least in part, within the internal cavity which is defined by the electrical coil form, and wherein the energizing of the concentric electrical coil effects a reciprocal motion of the elongated and moveable coil form so as to propel the mounting fixture along a linearly, reciprocal path of travel.
